(19) United States
(12) Patent Application Publication
(10) Pub. No.: US 2025/0181690 A1
(43) Pub. Date: Jun. 5, 2025

(54) Composite Voice-Based Authentication

(71) Applicant: ZEBRA TECHNOLOGIES CORPORATION, Lincolnshire, IL (US)

(72) Inventors: Joydeep Chakraborty, Bangalore (IN); Avinash G. Nijampure, Bangalore (IN); Sundaresan Sundaram, Bangalore (IN); Nabiraj Seethalaprasad, Bangalore (IN); Amit S. Mehta, Bangalore (IN)

(21) Appl. No.: 18/529,880

(22) Filed: Dec. 5, 2023

(51) Int. Cl. G06F 21/32; G06F 21/34

(52) U.S. Cl. CPC G06F 21/32; G06F 21/34

(57) ABSTRACT

A method in a computing device includes: in response to an authentication request, retrieving (i) a reference voiceprint, and (ii) an authentication value; selecting a transformation for application to the authentication value to generate a derived value; generating a prompt indicating the transformation; obtaining audio data responsive to the prompt, the audio data containing a candidate derived value; determining whether (i) the candidate derived value matches the derived value, and (ii) a candidate voiceprint of the audio data matches the reference voiceprint; and selecting an authentication action based on the determination.

### BACKGROUND

In some computing systems, voiceprint-based authentication may be employed to gain access to devices, information, or the like within the system. Voiceprint-based authentication may be compromised by recorded audio, however.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram of a system for composite voice-based authentication.

FIG. 2 is a flowchart of a method of composite voice-based authentication.

FIG. 3A is a diagram illustrating an example performance of blocks 205 and 210 of the method of FIG. 2.

FIG. 3B is a diagram illustrating another example performance of blocks 205 and 210 of the method of FIG. 2.

FIG. 4 is a diagram illustrating an example performance of blocks 215 and 220 of the method of FIG. 2.

FIG. 5 is a diagram illustrating an example performance of blocks 225, 230, and 245 of the method of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method in a computing device, the method comprising: in response to an authentication request, retrieving (i) a reference voiceprint, and (ii) an authentication value; selecting a transformation for application to the authentication value to generate a derived value; generating a prompt indicating the transformation; obtaining audio data responsive to the prompt, the audio data containing a candidate derived value; determining whether (i) the candidate derived value matches the derived value, and (ii) a candidate voiceprint of the audio data matches the reference voiceprint; and selecting an authentication action based on the determination.

Additional examples disclosed herein are directed to a computing device, comprising: a memory; and a processor configured to: in response to an authentication request, retrieve (i) a reference voiceprint, and (ii) an authentication value; select a transformation for application to the authentication value to generate a derived value; generate a prompt indicating the transformation; obtain audio data responsive to the prompt, the audio data containing a candidate derived value; determine whether (i) the candidate derived value matches the derived value, and (ii) a candidate voiceprint of the audio data matches the reference voiceprint; and select an authentication action based on the determination.

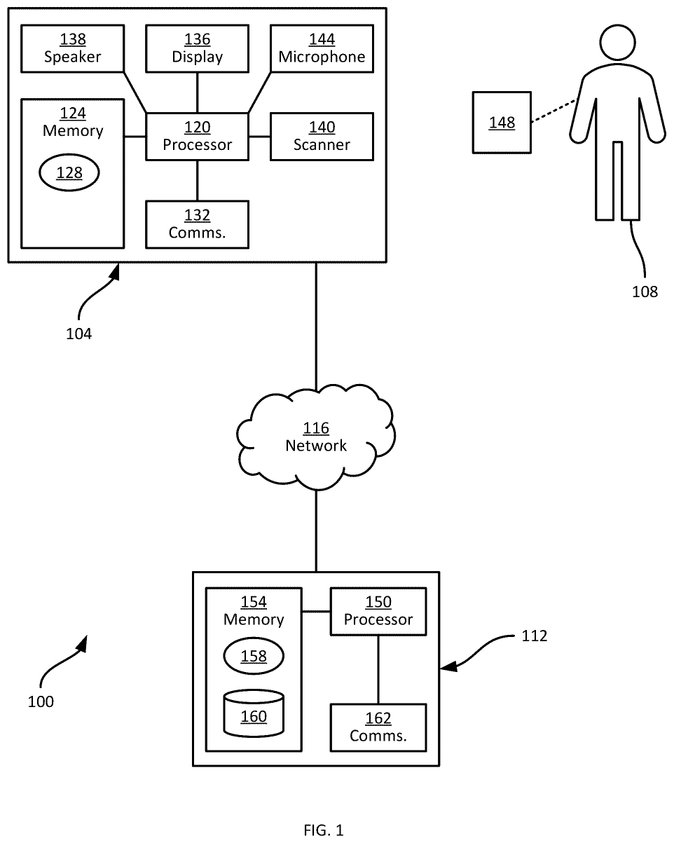

FIG. 1 illustrates a system 100 for composite voice-based authentication. The system 100 includes a computing device 104, such as wearable computer (e.g., a finger-mounted barcode scanner, a wrist-mounted computer, smart glasses), a handheld computer, a mobile printer, or the like. The system 100 can be configured to implement authentication functions to control access to the device 104 and/or a resource associated with the device 104, to a user 108. The authentication functions implemented by the system 100 can control access to data, applications, and the like on the device 104, e.g., as an alternative to provision of a user identifier and a typed password to the device 104 by the user 108.

In other examples, the device 104 can be disposed or otherwise associated with a physical location, such as to control a lock or other access-control device to a restricted area of a facility. In those examples, the authentication functions implemented by the system 100 can control access to the restricted area. In further examples, the user 108 may access, in addition to or instead of applications and/or data residing at the device 104, applications and/or data at another computing device such as a server 112. The user 108 can access applications and/or data at the server 112 via the device 104 and a network 116 (e.g., a suitable combination of local and wide-area networks), following successful authentication.

The device 104 includes, in the illustrated example, a processor 120, such as a central processing unit (CPU), graphics processing unit (GPU), application-specific integrated circuit (ASIC), or the like, communicatively coupled with a non-transitory computer-readable storage medium such as a memory 124, e.g., a combination of volatile memory elements (e.g., random access memory (RAM)) and non-volatile memory elements (e.g., flash memory or the like). The memory 124 stores a plurality of computer-readable instructions in the form of applications, including in the illustrated example an authentication application 128. Execution of the application 128 by the processor 120 configures the device 104 to implement authentication functionality as described below.

The device 104 also includes a communications interface 132, enabling the device 104 to communicate with other computing devices, such as the server 112, via the network 116. The communications interface 132 can therefore include any suitable combination of transceivers, antenna elements, and corresponding control hardware enabling communications over the network 116. In some examples, the interface 132 can also include hardware and associated firmware and/or software for implementing peer-to-peer communications, e.g., via Bluetooth™ or the like. The processor 120, memory 124, and communications interface 132 can be implemented as components of a system-on-chip (SoC) assembly, in some examples.

The device 104 can also include a display 136, which in some examples can be integrated with a touch screen. In other examples, the device 104 can include one or more inputs, e.g., keypads, buttons, or the like, distinct from the display 136. The device 104 can also include other output devices, such as a speaker 138, indicator light (not shown), or the like.

As will be understood by those skilled in the art, some authentication mechanisms involve providing, e.g., by a user seeking to gain access to data, applications, restricted areas or the like, an account identifier and a password, passphrase, personal identification number (PIN), or the like. The touch screen, keypad, or the like, of the device 104, however, may be limited in size and/or capabilities. For example, in the case of a hand-mounted scanner, the display 136 may be sufficiently small that providing a full soft keyboard thereon is impractical. Inputting a passphrase or the like to the device 104 by the user 108 may therefore also be impractical. In other examples, the device 104 may lack a tactile input device, also complicating the provision of a passphrase or the like by the user 108.

The device 104 can include additional input devices, such as a scanner 140 (e.g., a barcode scanner, a radio frequency identification (RFID) reader, or the like), and a microphone 144. As discussed below, the device 104 can be configured to employ the scanner 140 and/or the microphone 144 to capture authentication data associated with the user 108, as an alternative to keypad-based authentication. In particular, the device 104 can be configured to capture spoken audio from the user 108, and implement voiceprint-based authentication, using a previously established reference voiceprint.

Voiceprint-based authentication involves storing a mathematical representation (which may also be referred to as a reference voiceprint) of a voice of the user 108, and during an authentication process, capturing spoken audio from the user 108, generating a corresponding mathematical representation of the captured spoken audio, and comparing the newly generated mathematical representation to the reference voiceprint. If the newly generated mathematical representation matches the voiceprint, the origin of the spoken audio can be authenticated as the user 108. Such voiceprint-based authentication, however, may be compromised by a recording of the user 108 speaking, or synthetically generated audio derived from previous recordings of the user 108 speaking. The accuracy of voiceprint matching may suffer in some environments, such as warehouses or the like, in which environmental noise may complicate distinguishing between true speech (indicating the user 108 is physically present and speaking) and recorded or synthesized speech.

To mitigate the risk of compromise presented by such recordings or synthetic speech, while also reducing or avoiding the need for the user 108 to type passphrases or the like on the limited input hardware of the device 104, the system 100 is configured to implement a composite authentication mechanism that combines voiceprints with secret information known only to the user 108.

The composite authentication mechanism includes obtaining a reference voiceprint for the user 108, as well as an authentication value, such as a PIN, passphrase, or the like. The reference voiceprint and authentication value can be obtained from a physical token, such as an identity card 148 worn by the user 108 (e.g., with a 1D or 2D barcode, RFID tag, or the like encoding the reference voiceprint and authentication value). In other examples, the reference voiceprint and authentication value can be obtained from the server 112, via the network 116. To authenticate the user 108, the device 104 can then capture spoken audio that represents not the authentication value itself, but a derived value generated by applying a transformation to the authentication value, as described below.

The server 112 can include a processor 150, such as a central processing unit (CPU), graphics processing unit (GPU), application-specific integrated circuit (ASIC), or the like, communicatively coupled with a non-transitory computer-readable storage medium such as a memory 154, e.g., a combination of volatile memory elements (e.g., random access memory (RAM)) and non-volatile memory elements (e.g., flash memory or the like). The memory 154 stores a plurality of computer-readable instructions in the form of applications. In the present example, the memory 154 can store an authentication application 158. Execution of the application 158 by the processor 150 configures the server 112 to implement authentication functionality as described below. The memory 154 can also store a repository 160 containing a reference voiceprint and authentication value for the user 108 (and, as applicable, for other users with access to the system 100).

As will be apparent in the discussion below, certain portions of the authentication functionality implemented within the system 100 can be implemented by either one of the device 104 and the server 112. In some examples, the server 112 can be omitted, and the device 104 can perform the entire authentication mechanism. In other examples, the server 112 can perform at least a portion of the authentication mechanism.

The server 112 also includes a communications interface 162, enabling the server 112 to communicate with other computing devices, such as the device 104, via the network 116. The communications interface 162 can therefore include any suitable combination of transceivers, antenna elements, and corresponding control hardware enabling communications over the network 116. The processor 150, memory 154, and communications interface 162 can be supported in a housing, or implemented in a distributed format, e.g., in which a plurality of sets of computing hardware implement one logical computing device.

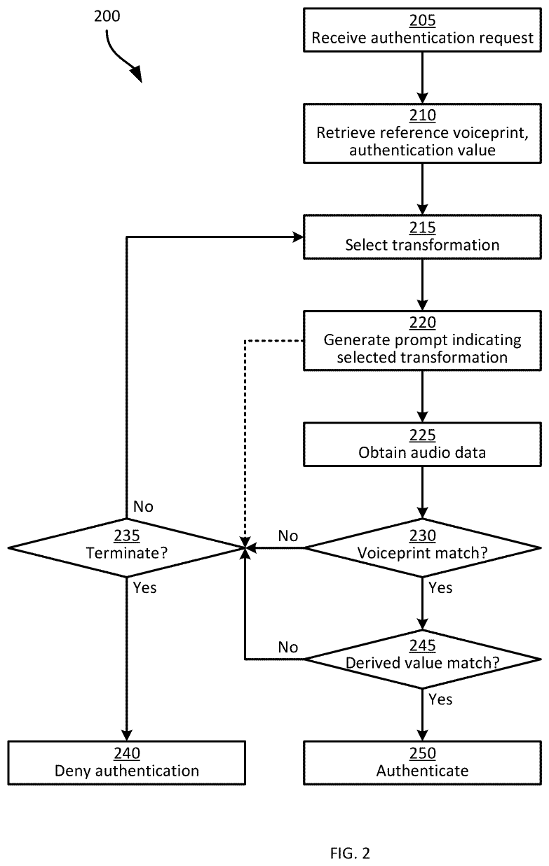

Turning to FIG. 2, a method 200 of composite voice-based authentication is illustrated. The method 200 is described below in conjunction with its performance within the system 100, e.g., by the device 104. As indicated in the discussion below, certain blocks of the method 200 can be performed by either the device 104 and the server 112, or the performance of such blocks can be shared between the device 104 and the server 112.

At block 205, the device 104 is configured to receive an authentication request. The authentication request can include, for example, an activation of an input on the device 104 by an operator (e.g., the user 108, although at this stage the identity of the operator may not be known to the device 104). The device 104 can track, for example, whether an authenticated user session is active, and if there is no active authenticated user session, any input received at the device 104 can be processed as an authentication request (e.g., preventing any further use of the device 104 until authentication is complete).

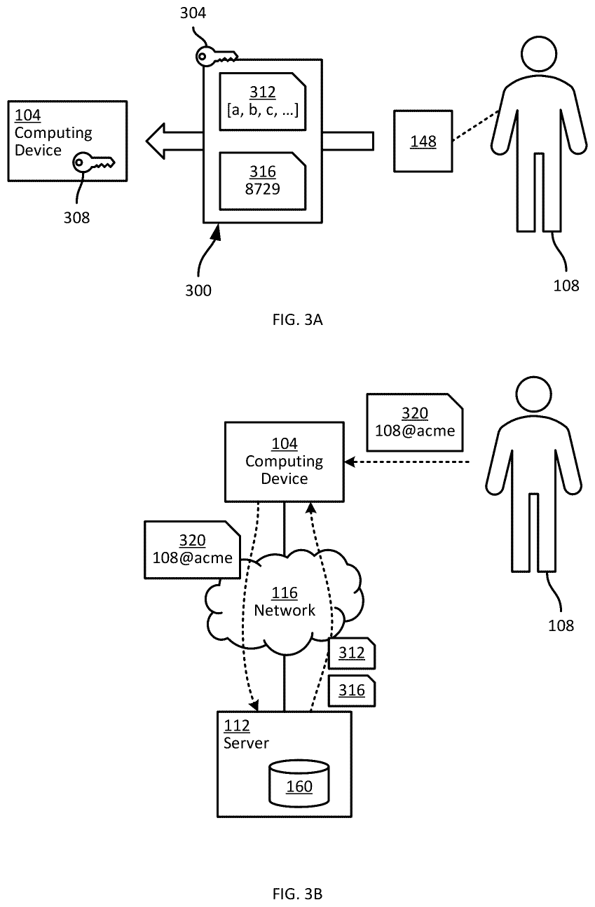

At block 210, the device 104 is configured to retrieve a reference voiceprint and an authentication value, for use in authenticating the operator that initiated the authentication process at block 205. In some examples, the device 104 can retrieve the reference voiceprint and authentication value from the identity card 148 or another suitable token. For example, referring to FIG. 3A, the processor 120 can be configured to control the scanner 140 to perform an RFID read, barcode scanning operation, or the like, to retrieve the reference voiceprint and authentication value encoded in a barcode affixed to the identity card 148, stored in an RFID tag embedded in the identity card 148, or the like. For example, the identity card 148 can store (e.g., encoded in a barcode, stored in an RFID tag, or the like) an authentication data payload 300 encrypted with a key 304 for which the device 104 stores a corresponding decryption key 308. For example, the key 308 may be provisioned to the device 104 and any other devices in the system 100 by a manufacturer of the device 104, enabling the device 104 to decrypt the payload 300 while preventing decryption of the payload 300 by a third party having come into possession of the identity card 148. The device 104 can therefore decrypt the payload 300 to obtain a reference voiceprint 312 (e.g., one or more vectors, arrays, or the like defining a voiceprint substantially unique to the user 108), and an authentication value 316. In this example, the authentication value is shown as a four-digit PIN “8729”, although in other examples the authentication value can include any suitable alphanumeric string.

Turning to FIG. 3B, another example performance of blocks 205 and 210 is illustrated. In the example of FIG. 3B, the user 108 can provide a client identifier 320, such as a user account or the like (e.g., “108@acme”) to the device 104, e.g., by capturing speech via the microphone 144 and performing automatic speech recognition (ASR) to extract the client identifier 320 from the captured speech. The device 104 can then be configured to send a request to the server 112 including the identifier 320. The server 112, in response to the request, can retrieve the reference voiceprint 312 and authentication value 316 from the repository 160 based on the client identifier 320, and return the reference voiceprint 312 and authentication value 316 to the device 104 (e.g., encrypted in some examples as described above).

Returning to FIG. 2, at block 215 the device 104 is configured to select a transformation for application to the authentication value to generate a derived value. The authentication process implemented by the system 100 prompts the user 108 for the derived value, rather than the authentication value itself. As a result, knowledge of the authentication value is necessary to produce the derived value, and the authentication value itself need not be spoken aloud or otherwise provided to the device 104 by the user 108, thus reducing the likelihood of the authentication value being intercepted. Further, prompting the user 108 for the derived value may impede machine-generated attempts at authenticating in place of the user 108.

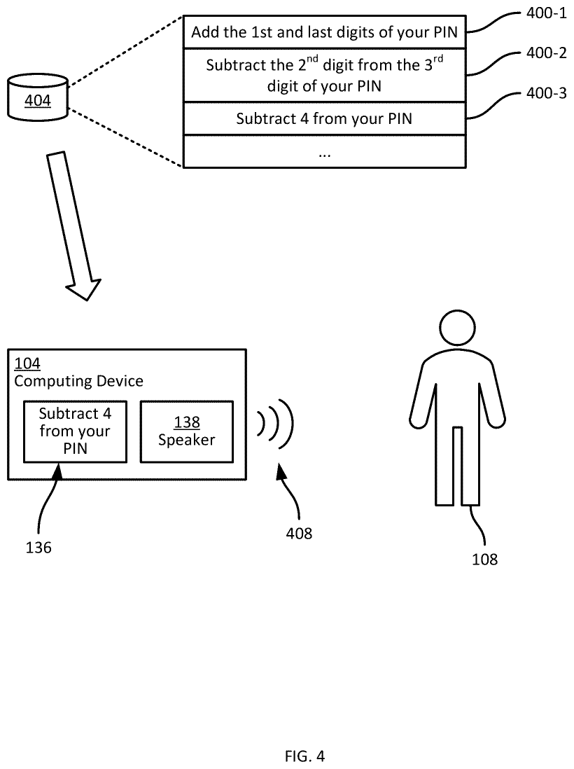

The transformation selected at block 215 can be selected from a repository of predetermined transformations, e.g., stored in the memory 124, as a component of the application 128, or the like. For example, the device 104 can be configured to select one of the predetermined transformations at random from the stored set. Turning to FIG. 4, the device 104 can be configured to select, e.g., at random, one of a plurality of transformations 400-1, 400-2, 400-3 (collectively referred to as the transformations 400, and generically as a transformation 400), and so on, stored in a repository 404. Each transformation 400 includes a description, as shown in FIG. 4, and can also include machine-readable instructions enabling the processor 120 to determine the corresponding derived value.

As shown in FIG. 4, each transformation is an arithmetic operation effected on some or all the digits of the authentication value. For example, the transformation 400-1 includes summing the first and last digits of the authentication value, the transformation 400-2 includes subtracting the second digit from the third digit, and the transformation 400-3 includes subtracting a value of four from the authentication value. A wide variety of other transformations 400 can also be stored in the repository 404 for selection at block 215. When the authentication value is not a numerical value, e.g., when the authentication value is a passphrase, password, or the like, the transformations 400 can include manipulations of the authentication value such as speaking the second letter of each word in a passphrase, or the like.

In examples in which the device 104 retrieves the reference voiceprint 312 and authentication value 316 from the server 112, the device 104 can also receive the transformation from the server 112. That is, the server 112 can perform the selection at block 215, e.g., from transformations stored in the memory 154, and send the selected transformation to the device 104 along with the reference voiceprint 312 and authentication value 316.

Referring again to FIG. 2, at block 220 the device 104 is configured to generate a prompt indicating the transformation selected at block 215 (whether the transformation was selected the device 104 or by the server 112). Returning to FIG. 4, generating the prompt at block 220 can include executing a text-to-speech process at the processor 120 and controlling the speaker 138 to generate an audible representation 408 of the selected transformation obtained via the text-to-speech process. The audible representation 408, when heard by the user 108, prompts the user 108 to determine the derived value obtained by applying the selected transformation 400 to the authentication value 316, and speak the derived value.

In other examples, the device 104 can control the display 136 to present the prompt at block 220, as also shown in FIG. 4. In some examples, the device 104 can determine whether to generate the prompt at block 220 via the display 136 or the speaker 138 based on whether the speaker 138 includes a private playback device, such as headphones, earbuds, or the like. For example, when a private playback device is connected to the device 104, the device 104 can be configured to generate an audible prompt via the speaker 138 (or separate playback device, if the private playback device is distinct from the speaker 138). When the device 104 does not detect a private playback device, however, the device 104 can be configured to present the prompt on the display 136 instead of audibly, e.g., to reduce the likelihood of the prompt being overheard.

In response to the prompt, at block 225, the device 104 is configured to obtain audio data containing a candidate derived value. For example, the processor 120 can control the microphone 144 to begin capturing audio after the prompt is presented at block 220. The audio data captured at block 225 is expected to contain an audible representation of the candidate derived value. The processor 120 can control the microphone 144 to record, for example, until a timeout period has elapsed (e.g., five seconds, although shorter or longer periods can be employed), or until a magnitude of detected sound falls below a threshold, indicating that the user 108 has stopped speaking. In other examples, the server 112 can perform block 225. For example, the device 104 can be configured to capture spoken audio from the user 108, and to forward the captured audio data to the server 112 for the further processing described below.

At block 230, the device 104 (or the server 112, if the audio data was obtained from the device 104 at the server 112 at block 225) is configured to determine a candidate voiceprint based on the captured audio data, and to determine whether the candidate voiceprint matches the reference voiceprint 312 from block 210. Determining a candidate voiceprint can include applying any suitable algorithm, or set of algorithms, to the audio data from block 225, to generate a voiceprint that can be compared to the reference voiceprint 312. The generation of the candidate voiceprint can, for example, include applying the same processing to the audio data from block 225 as was applied to generate the reference voiceprint 312.

When the determination at block 230 is negative, the device 104 proceeds to block 235, to determine whether to terminate the authentication attempt. For example, if a threshold number of unsuccessful authentication attempts (e.g., three, although a wide variety of other thresholds can be implemented) have been made through previous performances of blocks 205 to 230, the determination at block 235 may be affirmative, and at block 240, the device 104 can deny authentication, e.g., blocking access to the device 104 by the user 108 (or other operator attempting to authenticate as the user 108). The device 104 can ignore further authentication attempts for a predefined period of time, for example.

When the determination at block 235 is negative, e.g., if the threshold number of attempts has not been reached, the device 104 can return to block 215. In other examples, block 235 can be omitted, and a negative determination at block 230 can lead directly to denial at block 240. As will now be apparent, when the server 112 performs block 225 and block 230, the server 112 can be configured to transmit the result of the determination at block 230 to the device 104.

When the determination at block 230 is affirmative, the device 104 (or the server 112, when the audio from block 225 is passed to the server 112 for processing) proceeds to block 245 and determines whether the candidate derived value matches the derived value obtained by applying the transformation from block 215 to the authentication value 316. The device 104 can apply any suitable ASR technique to extract, from the audio captured at block 225, the candidate derived value in machine-readable form. The device 104 is then configured to compare the candidate derived value with a derived value obtained by applying the selected transformation to the authentication value 316. If the candidate derived value matches the derived value, the determination at block 245 is affirmative, and the device 104 proceeds to block 250 and authenticates the user 108. In other words, at block 250 the user 108 is granted access to applications and/or data on the device 104, the server 112, to a restricted area, or the like. When the determination at block 245 is negative, the device 104 proceeds to block 235, as described above.

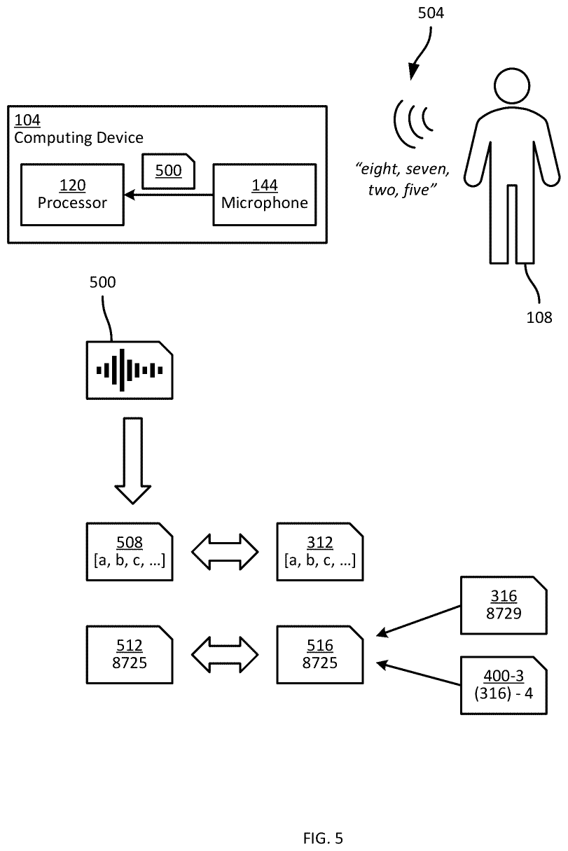

FIG. 5 illustrates an example performance of blocks 225, 230, and 245. At block 225, the device 104 captures, via the microphone 144, audio data 500 representing speech 504 of the user 108. From the audio data 500, the processor 120 can be configured to generate a candidate voiceprint 508, and to extract (e.g., via ASR) a candidate derived value 512. The candidate voiceprint 508 can then be compared to the reference voiceprint 312, and the candidate derived value 512 can be compared to a derived value 516 obtained by applying the transformation (e.g., the transformation 400-3, in this example) to the authentication value 316. When, as shown in FIG. 5, the candidate voiceprint 508 and the candidate derived value 512 match the reference voiceprint 312 and the derived value 516, the device 104 can authenticate the user 108.

The determinations at block 230 and 245 can be performed in the opposite order from that illustrated in FIG. 2, or can be performed substantially simultaneously (e.g., in parallel, rather than sequentially). The positive authentication action at block 250 is selected only when both determinations at blocks 230 and 245 are affirmative. When either of the determinations at block 230 and 245 is negative, the negative authentication action at block 235 (when an attempt threshold is implemented) or block 240 (when block 235 is omitted, or when the attempt threshold has been reached) is selected. Authenticating the user 108 can include, for example, transmitting a message to the server 112 indicating that the client identifier corresponding to the user 108 has been authenticated, initiating an authenticated user session at the device 104, or the like. Initiating an authenticated user session can include executing one or more client applications, activating a user interface, or the like.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a computing device, the method comprising:
in response to an authentication request, retrieving (i) a reference voiceprint, and (ii) an authentication value;
selecting a transformation for application to the authentication value to generate a derived value;
generating a prompt indicating the transformation;
obtaining audio data responsive to the prompt, the audio data containing a candidate derived value;
determining whether (i) the candidate derived value matches the derived value, and (ii) a candidate voiceprint of the audio data matches the reference voiceprint; and
selecting an authentication action based on the determination.

2. The method of claim 1, wherein generating the prompt includes controlling a speaker to generate an audible representation of the transformation.

3. The method of claim 2, further comprising, prior to controlling the speaker, determining that the speaker is a private playback device.

4. The method of claim 1, wherein generating the prompt includes controlling a display to present the transformation.

5. The method of claim 1, wherein retrieving the reference voiceprint and the authentication value includes:
capturing the reference voiceprint and the authentication value from a physical token via a scanner of the computing device.

6. The method of claim 1, wherein retrieving the reference voiceprint and the authentication value includes:
receiving a client identifier associated with the reference voiceprint and the authentication value; and
retrieving the reference voiceprint and the authentication value from a repository, based on the client identifier.

7. The method of claim 1, wherein selecting the transformation includes:
maintaining a plurality of transformations; and
randomly selecting one of the plurality of transformations.

8. The method of claim 1, wherein selecting the authentication action includes:
approving the authentication request when the candidate derived value matches the derived value and the candidate voiceprint matches the reference voiceprint; and
otherwise denying the authentication request.

9. A computing device, comprising:
a memory; and
a processor configured to:
in response to an authentication request, retrieve (i) a reference voiceprint, and (ii) an authentication value;
select a transformation for application to the authentication value to generate a derived value;
generate a prompt indicating the transformation;
obtain audio data responsive to the prompt, the audio data containing a candidate derived value;
determine whether (i) the candidate derived value matches the derived value, and (ii) a candidate voiceprint of the audio data matches the reference voiceprint; and
select an authentication action based on the determination.

10. The computing device of claim 9, further comprising a speaker;
wherein the processor is configured to generate the prompt by controlling the speaker to generate an audible representation of the transformation.

11. The computing device of claim 10, wherein the processor is further configured, prior to controlling the speaker, to determine that the speaker is a private playback device.

12. The computing device of claim 8, further comprising a display;
wherein the processor is configured to generate the prompt by controlling the display to present the transformation.

13. The computing device of claim 8, further comprising a scanner; wherein the processor is configured to retrieve the reference voiceprint and the authentication value by:
capturing the reference voiceprint and the authentication value from a physical token via the scanner.

14. The computing device of claim 8, wherein the processor is configured to retrieve the reference voiceprint and the authentication value by:
receiving a client identifier associated with the reference voiceprint and the authentication value; and
retrieving the reference voiceprint and the authentication value from a repository in the memory, based on the client identifier.

15. The computing device of claim 8, wherein the processor is configured to select the transformation by:
maintaining a plurality of transformations in the memory; and
randomly selecting one of the plurality of transformations.

16. The computing device of claim 8, wherein the processor is configured to select the authentication action by:
approving the authentication request when the candidate derived value matches the derived value and the candidate voiceprint matches the reference voiceprint; and
otherwise denying the authentication request.
